(19) United States
(12) Patent Application Publication
(10) Pub. No.: US 2014/0152489 A1
(43) Pub. Date: Jun. 5, 2014

(54) HIGH-FREQUENCY OCEAN SURFACE RADAR USING FREQUENCY MULTIPLEXING AND ORTHOGONAL WAVEFORMS

(71) Applicants: Electronics and Telecommunications Research Isntitute, (US); Hannam University Institute for Industry-Academia Cooperation, (US)

(72) Inventors: Joo Hwan LEE, Daejeon (KR); Dong-Uk SIM, Daejeon (KR); Young Jun CHONG, Daejeon (KR); Jong Ho KIM, Daejeon (KR); YOUNG KEUN YOON, Daejeon (KR); Myoung-Won JUNG, Daejeon (KR); In-Sik CHOI, Daejeon (KR)

(73) Assignees: Hannam University Institute for Industry-Academia Cooperation, Daejeon (KR); Electronics and Telecommunications Research Institute, Daejeon (KR)

(21) Appl. No.: 13/870,811

(22) Filed: Apr. 25, 2013

(30) Foreign Application Priority Data
Dec. 4, 2012 (KR) 10-2012-0146177

(51) Int. Cl. G01S 7/02

(52) U.S. Cl. CPC G01S 7/023
USPC 342/85

(57) ABSTRACT

A method of reusing a frequency by allocating two orthogonal signal waveforms to the same frequency band is as follows. Two high-frequency ocean surface radars can be operated in the same frequency band without mutual interference by allocating a signal having an up-chirped LFM waveform and a signal having a down-chirped LFM waveform, having the same frequency band, to the two radars by employing an orthogonal characteristic between the two signals. Furthermore, a plurality of radars located within a distance within which interference is possible can be operated without mutual interference by combining and allocating two orthogonal signals and a plurality of frequency bands.

### RELATED APPLICATION(S)

This application claims the benefit of Korean Patent Application No. 10-2012-0146177, filed on Dec. 14, 2012, which is hereby incorporated by references as if fully set forth herein.

### FIELD OF THE INVENTION

The present invention relates to a frequency reuse method in a high-frequency ocean surface radar and, more particularly, to a frequency reuse method suitable for increasing the accuracy of information about the state of the ocean surface and for efficiently reusing frequency resources by using both a multiplexed frequency and waveforms having an orthogonal characteristic.

### BACKGROUND OF THE INVENTION

A high-frequency ocean surface radar is an apparatus for measuring the state of the ocean surface, such as the velocity of moving fluid and the flow rate, by radiating electric waves having a high frequency from an antenna installed on land and analyzing back scattering waves reflected by the waves of the ocean surface. The high-frequency ocean surface radar is advantageous in that it can observe large areas of the sea continuously and simultaneously and can observe the sea area from land for a long time without the need to install a sensor for measurement of the sea.

The principle by which measurements are taken using the high-frequency ocean surface radar is as follows.

First, when radars installed at two or more places on land send signals, the Doppler spectrum of the signals reflected by and returned from the ocean surface is analyzed, relative data measured by respective observatories are aggregated, and the velocity of a moving fluid and the flow rate of the ocean surface at each point are checked based on the result of the aggregation. Here, the intensity of a back scattering wave reflected by the ocean surface becomes the maximum in a frequency band comprising frequencies having wavelengths that are half the wavelength (i.e., 10 m to 100 m) of waves on the ocean surface, in accordance with the Bragg Scattering principle. Thus, a frequency having a high frequency band (i.e., 3 MHz to 30 MHz) is used in the ocean surface radar.

In the high-frequency ocean surface radar, a Frequency Modulation Continuous Wave (FMCW) signal, which enables high-output transmission, is used to search a large area of the ocean surface. In general, in order to obtain resolution for an area of 1 km, a bandwidth of about 150 kHz is necessary and the resolution increases as the bandwidth becomes wider. In high-frequency ocean surface radars operating in Korea, a signal having a bandwidth ranging from 50 kHz to 500 kHz is being used.

As described above, the bandwidth of a transmission signal used in each high-frequency ocean surface radar occupies a relatively larger area than the bandwidth of the usable frequency band (i.e., 3 MHz to 30 MHz). For example, in the case of FM radio broadcasting using a VHF band of 30 MHz to 300 MHz, only a bandwidth of 5 kHz per channel is used.

Accordingly, if a plurality of high-frequency ocean surface radars operates at the same time in a limited frequency band, there is a need for frequency reuse technology which prevents interference between radar signals and also enables efficient frequency use. In particular, frequency reuse technology becomes more important in order to operate a plurality of high-frequency ocean surface radars while maintaining independence from existing radars and communication systems operating in a relatively small area such as Korea.

A first example of the frequency reuse technology includes a time multiplexing scheme in which a plurality of radars sends synchronized signals in the same frequency band at different times. The time multiplexing scheme is subdivided into a station sequencing scheme and a pulse-to-pulse interleaving scheme.

In the station sequencing scheme, radars sequentially send their FMCW signals during occupation periods that correspond to several minutes. This scheme is disadvantageous in that information on the state of the ocean surface obtained as a result of data composition is not very accurate, because the radars obtain pieces of information on the state of the ocean surface during respective time bands (e.g., a difference between several minutes to several tens of minutes).

In the pulse-to-pulse interleaving scheme, a short pulse or a coded pulse is used as a transmission signal, and the process of one radar sending and receiving pulses and the other radar sending and receiving pulses is repeated. If this scheme is used, transmission power is reduced because the distance between the transmission pulses of the respective radars increases according to the increase in the number of operating radars. Accordingly, there is a disadvantage in that a maximum detection distance is limited.

A second example of such frequency reuse technology includes a frequency multiplexing scheme, in which radars use transmission signals having different frequencies. This scheme is disadvantageous in that the efficiency of frequency use is low because radars within a distance within which interference is possible (e.g., in the case of radars operating in Korea, the distance within which interference is possible is about 20 km to 160 km) cannot use the same frequency.

The frequency reuse schemes have disadvantages in that the accuracy of analysis results can be low, in that the detection distance can be limited, and in that the efficiency of use of frequency resources is low.

### SUMMARY OF THE INVENTION

The present invention provides a frequency reuse method capable of continuously observing a large area of the ocean surface in real time, increasing the accuracy of information on the state of the ocean surface by overcoming the disadvantages of existing frequency reuse schemes, and efficiently reusing frequency resources.

In accordance with an aspect of the present invention, a frequency reuse apparatus may include a reset unit for resetting the number of repetitions for a frequency reuse method for two or more radars, a parameter input unit for receiving parameters for the two or more radars, a minimum separation distance determination unit for determining the minimum separation distance between the two or more radars from a maximum detection distance between the two or more radars, an interference distance condition determination unit for determining whether interference is present between the two or more radars, and a frequency and waveform determination unit for determining the frequency and the waveform to be used by each of the two or more radars without interference.

The frequency and waveform determination unit may allocate a signal having an up-chirped Linear Frequency Modulation (LFM) waveform and a signal having a down-chirped LFM waveform to the respective two or more radars, and the signal having the up-chirped LFM waveform and the signal having the down-chirped LFM waveform may occupy the same frequency band.

The distance between the two or more radars may be greater than twice the minimum separation distance.

The frequency and waveform determination unit may combine a plurality of frequency bands with the signal having the up-chirped LFM waveform and the signal having the down-chirped LFM waveform, and may simultaneously allocate the combined frequencies and signal waveforms to the two or more radars.

The distance between the two or more radars may be less than twice the minimum separation distance.

The frequency reuse apparatus may further include an end determination unit for determining whether the frequency reuse method has ended or not.

In accordance with another aspect of the present invention, a frequency reuse method of a frequency reuse apparatus may include resetting the number of repetitions for a frequency reuse method for two or more radars, receiving parameters for the two or more radars, determining the minimum separation distance between the two or more radars from a maximum detection distance of the two or more radars, determining whether interference is present between the two or more radars, and determining the frequency and the waveform that can be used by each of the two or more radars without interference.

The determination of the frequency and the waveform to be used by each of the two or more radars without interference may include allocating a signal having an up-chirped Linear Frequency Modulation (LFM) waveform and a signal having a down-chirped LFM waveform to the respective two or more radars, the signal having the up-chirped LFM waveform and the signal having the down-chirped LFM waveform having identical frequency bands.

The distance between the two or more radars may be greater than twice the minimum separation distance.

The frequency reuse method may further include transmitting the signal having the up-chirped LFM waveform and the signal having the down-chirped LFM waveform, having the same frequency band, from the two or more radars to the ocean surface and performing matched filtering between signal waveforms reflected by and received from the ocean surface.

The determination of the frequency and the waveform to be used by each of the two or more radars without interference may include combining a plurality of frequency bands with the signal having the up-chirped LFM waveform and the signal having the down-chirped LFM waveform and simultaneously allocating the combined frequencies and signal waveforms to the two or more radars.

The distance between the two or more radars may be less than twice the minimum separation distance.

The frequency reuse method may further include determining whether the frequency reuse method has ended or not.

### BRIEF DESCRIPTION OF THE DRAWINGS

The objects and features of the present invention will become apparent from the following description of embodiments given in conjunction with the accompanying drawings, in which:

FIG. 1 is a graph in which the characteristic of a signal having an up-chirped Linear Frequency Modulation (LFM) waveform applied to an embodiment of the present invention is represented on a time axis;

FIG. 2 is a graph in which the characteristic of a signal having a down-chirped Linear Frequency Modulation (LFM) waveform applied to an embodiment of the present invention is represented on a time axis;

FIG. 3 is a graph showing the results of a matched filtering operation between a signal having an up-chirped LFM waveform and a signal having a down-chirped LFM waveform applied to an embodiment of the present invention;

FIG. 4 is a diagram showing parameters related to two adjacent radars used in a frequency band and signal waveform allocation algorithm in accordance with an embodiment of the present invention;

FIG. 5 shows the construction of the frequency band and signal waveform allocation algorithm in accordance with an embodiment of the present invention;

FIG. 6 is a diagram illustrating the locations of high-frequency ocean surface radars;

FIG. 7 is a comparison table illustrating the frequency bands and maximum detection distances of the high-frequency ocean surface radar;

FIG. 8 is a comparison table illustrating the relative distance between the radars; and

FIG. 9 is a comparison table illustrating frequency bands and signal waveforms applied to high-frequency ocean surface radars in accordance with an embodiment of the present invention.

### DETAILED DESCRIPTION OF THE EMBODIMENTS

Hereinafter, embodiments of the present invention will be described in detail with reference to the accompanying drawings, which form a part hereof.

The merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the category of the claims. The same reference numbers will be used to refer to the same or similar parts throughout the drawings.

In describing embodiments of the present invention, a detailed description of known functions or constructions related to the present invention will be omitted if it is deemed that they would make the gist of the present invention unnecessarily vague. A preferred embodiment in accordance with the present invention is described in detail below with reference to the accompanying drawings. Furthermore, terms to be described later are defined by taking functions in embodiments of the present invention into consideration, and may be different according to the operator's intention or usages. Accordingly, the terms should be defined based on contents throughout the entire specification.

Combinations of each of the blocks in the accompanying block diagrams and each of the steps in the accompanying flowchart may be executed by computer program instructions. These computer program instructions may be installed in a processor of a general purpose computer, a special purpose computer, or other programmable data processing equipment, and thus the instructions executed by the processor of the computer or other programmable data processing equipment generate means for executing the functions described in each of the blocks of the block diagram or in each of the steps of the flowchart. These computer program instructions may also be stored in a computer-usable or computer-readable memory that can direct a computer or other programmable data processing equipment in order to function in a particular manner, and thus the instructions stored in the computer-usable or computer-readable memory produce an article of manufacture including instruction means for executing the functions described in each of the blocks of the block diagram or each of the steps of the flowchart. The computer program instructions may also be loaded onto a computer or other programmable data processing equipment to cause a series of operational steps to be performed on the computer or other programmable equipment, thus producing a computer-executable process. Accordingly, the instructions executed on the computer or other programmable equipment may provide steps for executing the functions described in each of the blocks of the block diagram or each of the steps of the flowchart.

Furthermore, each block or each step may represent part of a module, segment, or code including one or more executable instructions for executing specific logical function(s). It should also be noted that in some alternative implementations, the functions noted in the blocks or steps may occur in some other order. For example, two blocks or steps shown in succession may in fact be executed substantially concurrently, or the blocks or steps may sometimes be executed in the reverse order, depending upon the functionality involved.

In the present invention, both a frequency division multiplexing scheme and Linear Frequency Modulation (LFM) waveforms having an orthogonal characteristic are used for efficient frequency reuse.

A signal having an up-chirped LFM waveform whose frequency is linearly increased for a specific time and a signal having a down-chirped LFM waveform whose frequency is linearly decreased for a specific time have an orthogonal characteristic, and thus interference is not generated between the two signal waveforms even in the same frequency band. Accordingly, the two signal waveforms can be independently used even in the same frequency band.

The present invention can increase frequency reuse efficiency by combining the frequency bands of high-frequency ocean surface radars located within a distance within which interference is possible and the two signal waveforms having an orthogonal characteristic in operating the high-frequency ocean surface radars. The object of the present invention can be easily achieved by this technical spirit.

Embodiments of the present invention are described in detail with reference to the accompany drawings.

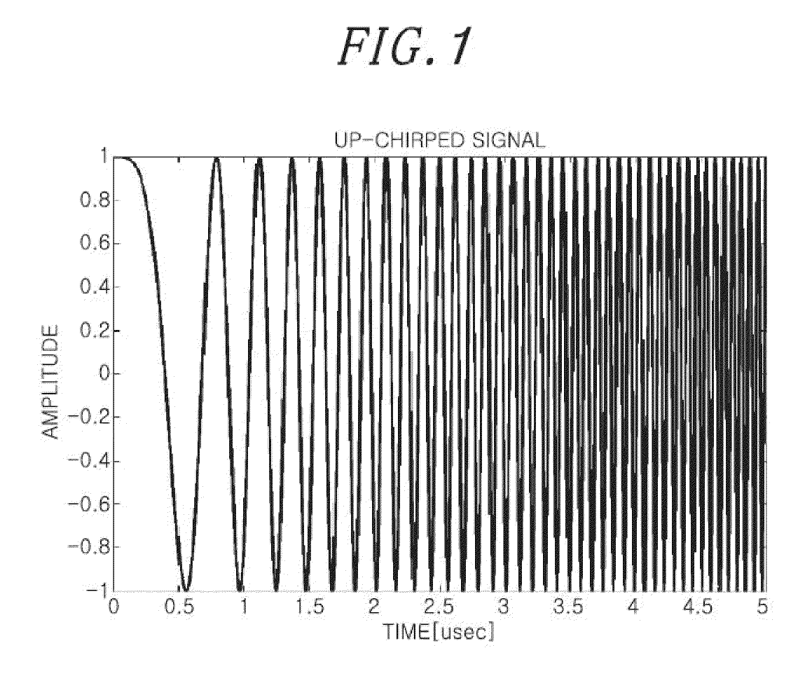

First, the signal having the up-chirped LFM waveform used in the present invention has a linearly increasing frequency, and the signal can be represented by Equation 1 below. The signal having the up-chirped LFM waveform on a time axis can be illustrated as in FIG. 1.

$$s ( t ) = rect ( \frac{t}{τ} ) exp ( j2π ( {f}_{0} t + \frac{μ}{2} {t}^{2} ) ) \qquad [ Equation 1 ]$$

Here, f₀ is a start frequency,

$$μ = \frac{B}{{τ}_{0}}$$

is the time length of the signal waveform, and ^{τ}0 is the width of a frequency band.

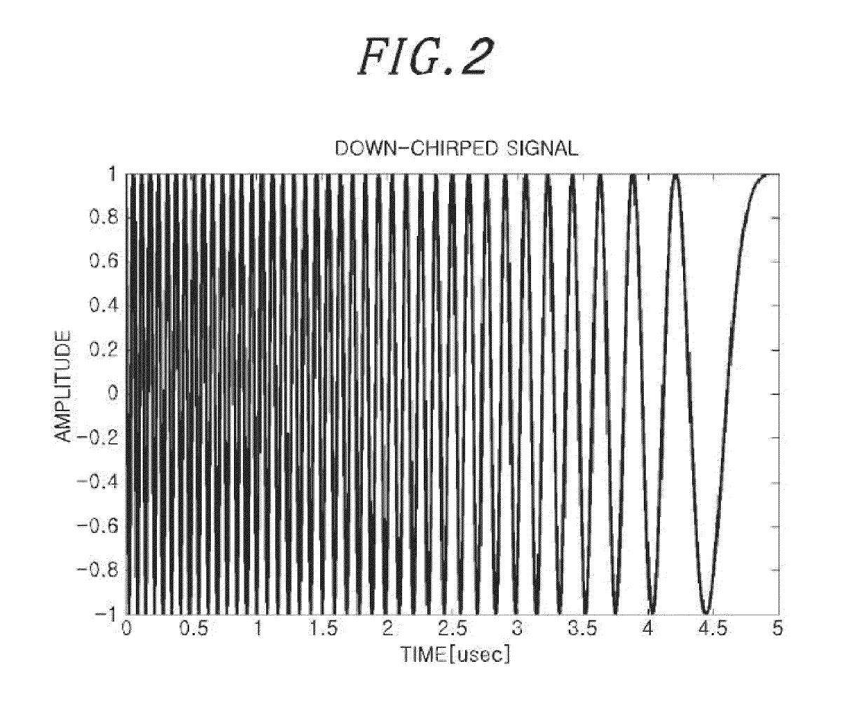

Furthermore, the signal having the down-chirped LFM waveform has a linearly decreasing frequency, and the signal can be represented by Equation 2 below. The signal having the down-chirped LFM waveform on a time axis can be illustrated as in FIG. 2.

$$s ( t ) = rect ( \frac{t}{τ} ) exp ( j2π ( {f}_{0} t - \frac{μ}{2} {t}^{2} ) ) \qquad [ Equation 2 ]$$

After an ocean surface radar sends the up-chirped LFM signal, a back scattering signal reflected by and returned from the portion of the ocean surface that is spaced apart from the ocean surface radar by a distance R can be represented by Equation 3 below.

$${S}_{r} = rect ( \frac{t - {t}_{0}}{τ} ) exp ( j2π {f}_{0} ( t - {t}_{0} ) + {jπμ ( t - {t}_{0} )}^{2} ) \qquad [ Equation 3 ]$$

Here,

$${t}_{0} = \frac{2 R}{c}$$

is the time that the up-chirped LFM signal transmitted by the ocean surface radar takes to be reflected by and received from the portion of the ocean surface that is spaced apart by the distance R.

In the same condition as described above, the down-chirped LFM signal can be represented by Equation 4 below.

$${S}_{r} = rect ( \frac{t - {t}_{0}}{τ} ) exp ( j2π {f}_{0} ( t - {t}_{0} ) - {jπμ ( t - {t}_{0} )}^{2} ) \qquad [ Equation 4 ]$$

Here, the result of execution of a matched filtering operation, such as that of Equation 5 below, can be represented between the transmitted up-chirped LFM signal of Equation 1 and the received up-chirped LFM signal of Equation 3 and between the transmitted down-chirped LFM signal of Equation 2 and the received up-chirped LFM signal of Equation 3.

Sₒᵤₜ (t)=Sᵣ(t) [symbol] S^{*}(t₀-t) Equation 5

In Equation 5, [symbol] indicates a convolution operation between the two signals, and * indicates a complex conjugate of the two signals.

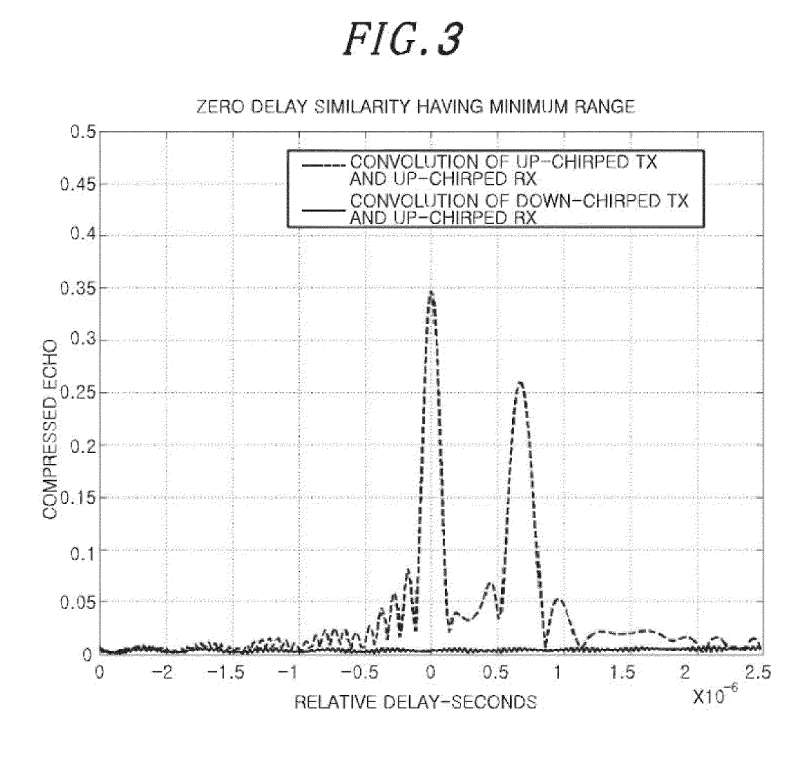

FIG. 3 is a graph illustrating Equation 5 and the result of the matched filtering operation between the up-chirped LFM signal and the down-chirped LFM signal applied to an embodiment of the present invention.

In FIG. 3, the dotted line indicates the result of the matched filtering operation between the transmitted up-chirped LFM signal and the received down-chirped LFM signal, and the solid line indicates the result of the matched filtering operation between the transmitted down-chirped LFM signal and the received up-chirped LFM signal.

As shown in FIG. 3, a meaningful information signal can be obtained from the result of the matched filtering operation between the transmitted up-chirped LFM signal and the received up-chirped LFM signal indicated by the dotted line, and an information signal having a level equal to or higher than a noise level does not appear in the result of the matched filtering operation between the transmitted down-chirped LFM signal and the received up-chirped LFM signal indicated by the solid line. That is, it can be seen that the up-chirped LFM signal and the down-chirped LFM signal have an orthogonal characteristic. As a result, it can be seen that a meaningful information signal can be obtained only when a matched filtering operation is performed between signals having the same waveform.

If two high-frequency ocean surface radars using the same frequency band within a distance within which interference is possible send an up-chirped LFM signal and a down-chirped LFM signal, respectively, and perform respective matched filtering operations between the waveforms of the transmitted up-chirped LFM and down-chirped LFM signals and waveforms reflected by and received from the ocean surface based on the above-described results, the resulting value having the same waveform, that is, a signal transmitted by one radar and then reflected by and received from the ocean surface, can be isolated and separated from the reflected signal waveforms. Accordingly, although the two high-frequency ocean surface radars have the same use frequency band, they can be independently operated without mutual interference.

For example, if a radar 1 uses a frequency band f₁ and a signal having an up-chirped LFM waveform and a radar 2 uses the frequency band f₁ and a signal having a down-chirped LFM waveform, the two radars can operate without mutual interference. That is, the two radars can operate in the same frequency band without interference.

Furthermore, if two orthogonal signal waveforms and a plurality of frequency bands are combined and allocated to a plurality of radars located within a distance within which interference is possible, the plurality of radars can operate without mutual interference, so frequency resources can be efficiently reused.

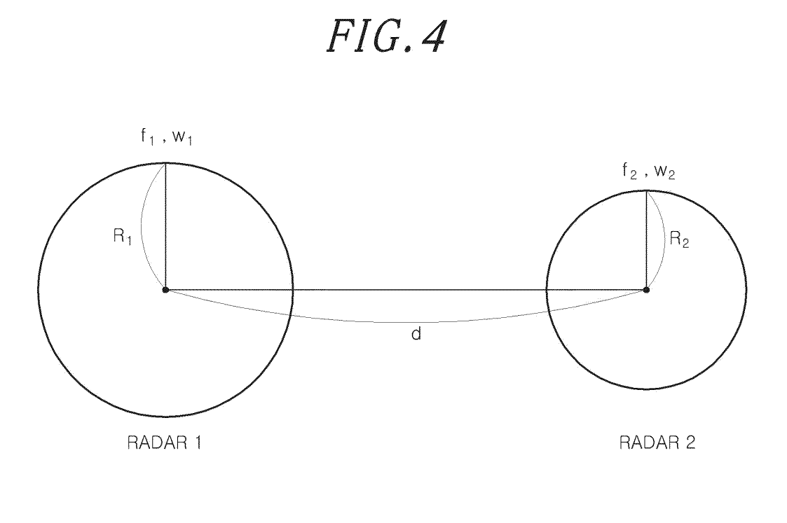

FIG. 4 is a diagram showing parameters related to radars used in a frequency reuse method in accordance with an embodiment of the present invention. In FIG. 4, f₁ and f₂ indicate operating frequencies, w₁ and w₂ indicate types of signal waveforms, d indicates the distance between a radar 1 and a radar 2, and R₁ and R₂ indicate maximum detection distances of the two radars.

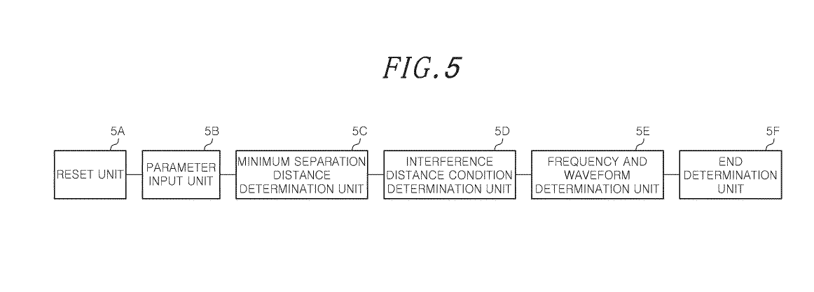

In accordance with an embodiment of the present invention, an apparatus configured to implement the frequency reuse method of a high-frequency ocean surface radar and to be capable of allocating frequencies that can operate without mutual interference and signal waveforms to specific radars can be configured as shown in FIG. 5. Referring to FIG. 5, the apparatus includes a reset unit 5a configured to reset the number of repetitions for the allocation of frequencies and signal waveforms, a parameter input unit 5b configured to receive parameters for two radars to be tested, a minimum separation distance determination unit 5c configured to determine the minimum separation distance between the two radars from a maximum detection distance between the two radars, an interference distance condition determination unit 5d configured to determine whether or not interference is occurring between the two radars, a frequency and waveform determination unit 5e configured to determine a frequency and a waveform to be used in each of the radars without interference, and an end determination unit 5f configured to determine the end of the frequency and signal waveform allocation algorithm.

The frequency reuse process of the high-frequency ocean surface radar in accordance with an embodiment of the present invention is described below in connection with the apparatus.

Step 1: First, the number of repetitions n for the allocation of frequencies and signal waveforms can be reset.

For example, the number of repetitions n can be set to 1.

Step 2: the parameters f₁, f₂, w₁, w₂, d, R_{I}, and R₂ for the two radars of FIG. 4 can be inputted.

Step 3: the minimum separation distance Rₛᵣ between the two radars without mutual interference can be determined. For example, if R1≧R2, then Rₛᵣ=R₁. If R₁<R₂, then Rₛᵣ=R₂.

Step 4: The distance d is compared with 2×Rₛᵣ. For example, if d≦2×Rₛᵣ, the radars are located within the distance within which interference is possible. Thus, w₁ and w₂ may be orthogonal waveforms, that is, an up-chirped LFM waveform and a down-chirped LFM waveform, or the operating frequencies f₁ and f₂ may be different from each other. Here, combinations used by the existing radars within an interference distance may be excluded from the combination of each usable frequency and each waveform. If d>2×Rₛᵣ, w₁ and w₂ may be the same, or f₁ and f₂ may be the same, because the two radars are not present within the distance within which interference is possible.

Step 5: n=n₁+1. If n is not equal to _{N}C₂+1, two specific radars not selected can be selected again and the steps 2 to 5 can be then repeated. If n is equal to _{N}C₂+1, the process is terminated.

If this process is performed, operable frequencies and signal waveforms can be efficiently allocated to specific radars without interference.

Results in which the frequency reuse method in accordance with an embodiment of the present invention were applied to the allocation of frequencies and signal waveforms to high-frequency ocean surface radars now operating in Korea are described below.

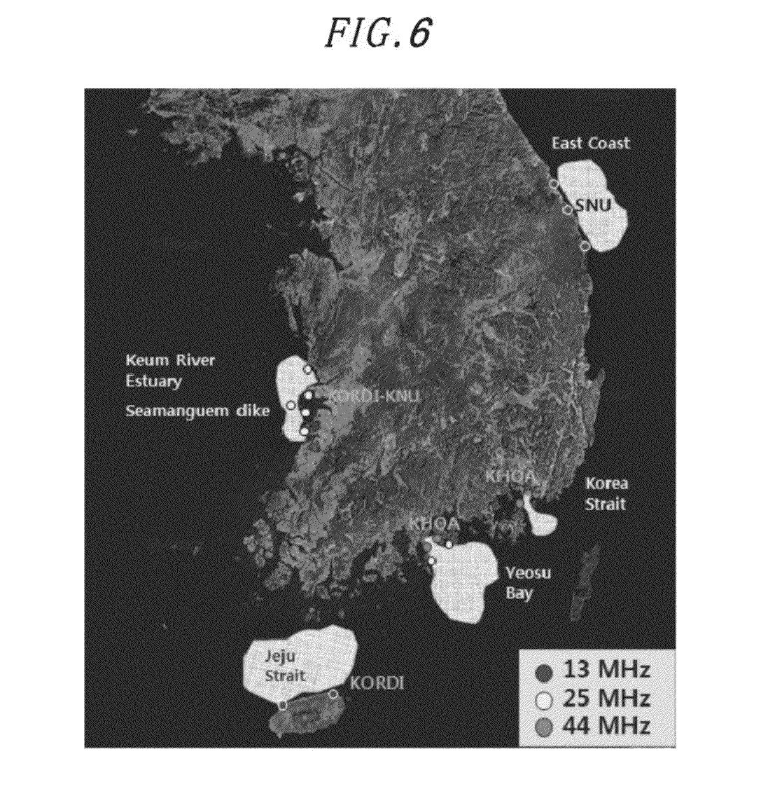

FIG. 6 is a diagram illustrating the locations of high-frequency ocean surface radars that are operating in Korea.

As can be seen from FIG. 6, 16 high-frequency ocean surface radars are operating, and detection areas include 6 regions: a Gangwon region, a Busan region, a Yeosu Harbor region, a Jeju region, a Saemangeum region, and a Gunsan region.

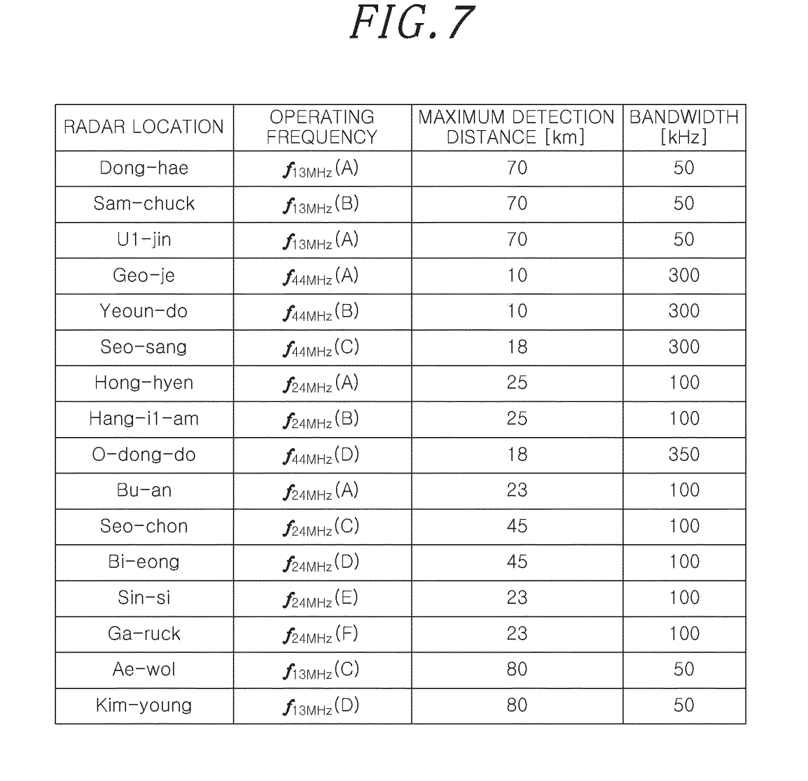

FIG. 7 shows the frequency band, the maximum detection distance, and the width of the frequency band of each of the 16 high-frequency ocean surface radars.

As can be seen from FIG. 7, the 16 radars use 14 different frequency bands, and alphabet letters A, B, C, D, E, and F refer to different operating frequencies allocated to the respective frequency bands. From among the 16 radars, radars are allocated to a 13 MHz band, 7 radars are allocated to a 25 MHz band, and 4 radars are allocated to a 43 MHz band. Each of the 16 radars can use, for example, a Frequency Modulated Continuous Wave (FMCW).

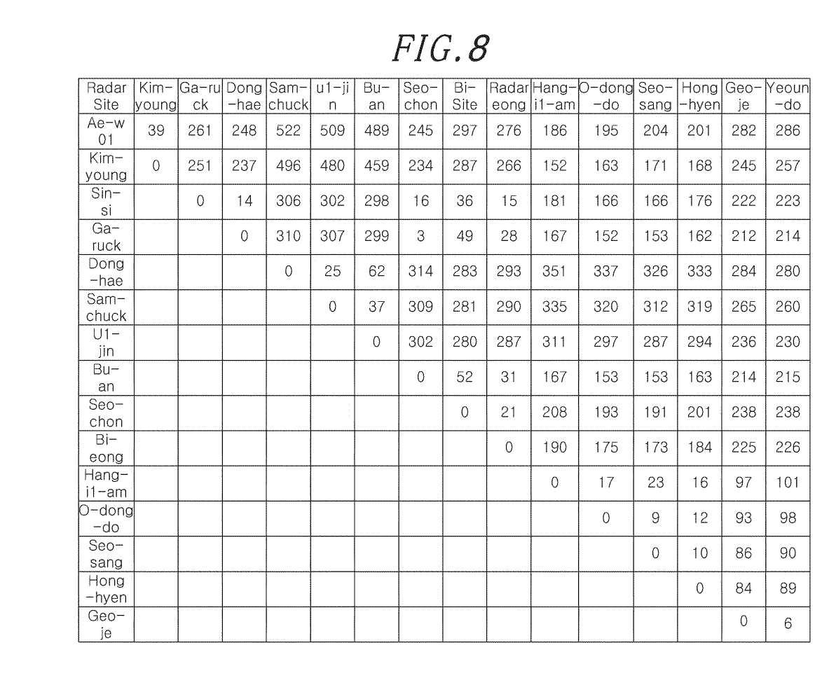

FIG. 8 illustrates the relative distance between the radars.

As described above in the process of allocating frequency bands and signal waveforms in FIG. 5, if the distance between two radars is greater than twice the minimum separation distance Rₛᵣ, the two radars can reuse the same frequency because interference between the two radars can be ignored. In contrast, if the distance between the two radars is less than twice the minimum separation distance Rₛᵣ, the two radars may use different frequencies or signals having orthogonal waveforms in order to avoid interference.

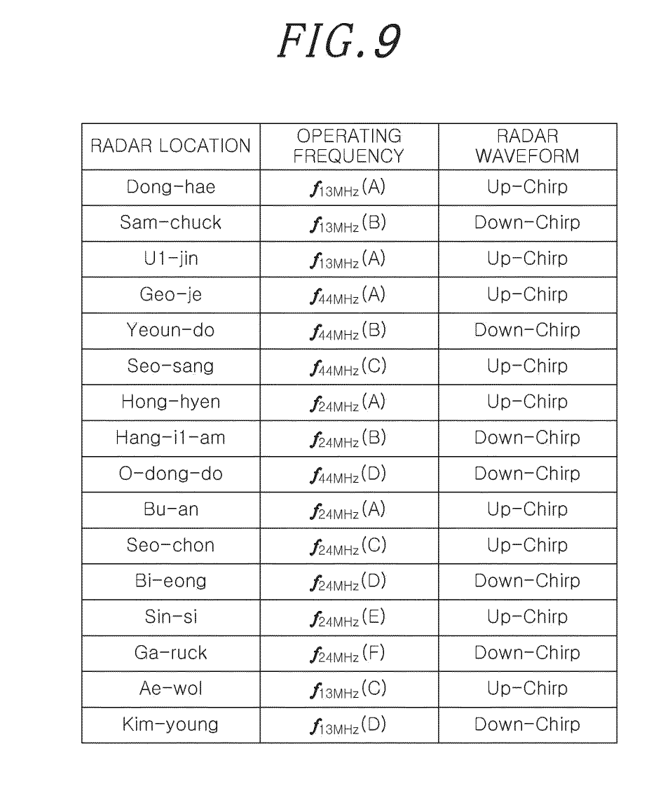

Results in which the frequency reuse method of the present invention were applied to high-frequency ocean surface radars now operating in Korea by using the frequency and signal waveform allocation algorithm are shown in FIG. 9.

FIG. 9 illustrates frequency bands and signal waveforms applied to respective high-frequency ocean surface radars. Referring to FIG. 9, frequency bands and orthogonal waveforms, that is, an up-chirped LFM waveform and a down-chirped LFM waveform, were combined and allocated to high-frequency ocean surface radars located within a distance within which interference is possible, and the same frequency was allocated to high-frequency ocean surface radars not located within the distance within which interference is possible.

From FIG. 9, it can be seen that 16 high-frequency ocean surface radars can be operated using only 6 frequency bands if the frequency reuse method of the present invention is used.

Accordingly, it can be confirmed that efficient frequency reuse is possible because the current number of 14 frequency bands can be reduced to 8 frequency bands.

In accordance with the embodiments of the present invention, each of high-frequency ocean surface radars consecutively uses a signal having an up-chirped LFM waveform or a down-chirped LFM waveform without time division. Accordingly, the accuracy of information on the state of the ocean surface can be increased because large areas can be continuously observed in real time. Furthermore, frequency reuse efficiency can be increased by using combinations of the two up-chirped LFM and down-chirped LFM waveforms having an orthogonal characteristic and a plurality of frequency bands.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A frequency reuse apparatus, comprising:
a reset unit for resetting a number of repetitions for a frequency reuse method for two or more radars;
a parameter input unit for receiving parameters for the two or more radars;
a minimum separation distance determination unit for determining a minimum separation distance between the two or more radars from a maximum detection distance between the two or more radars;
an interference distance condition determination unit for determining whether interference is present between the two or more radars; and
a frequency and waveform determination unit for determining a frequency and a waveform to be used by each of the two or more radars without interference.

2. The frequency reuse apparatus of claim 1, wherein the frequency and waveform determination unit allocates a signal having an up-chirped Linear Frequency Modulation (LFM) waveform and a signal having a down-chirped LFM waveform to the respective two or more radars, the signal having the up-chirped LFM waveform and the signal having a down-chirped LFM waveform having an identical frequency band.

3. The frequency reuse apparatus of claim 2, wherein a distance between the two or more radars exceeds twice the minimum separation distance.

4. The frequency reuse apparatus of claim 1, wherein the frequency and waveform determination unit combines a plurality of frequency bands with the signal having the up-chirped LFM waveform and the signal having the down-chirped LFM waveform and simultaneously allocates the combined frequencies and signal waveforms to the two or more radars.

5. The frequency reuse apparatus of claim 4, wherein a distance between the two or more radars is less than twice the minimum separation distance.

6. The frequency reuse apparatus of claim 1, further comprising an end determination unit for determining whether the frequency reuse method has ended or not.

7. A frequency reuse method of a frequency reuse apparatus, comprising:
resetting a number of repetitions for a frequency reuse method for two or more radars;
receiving parameters for the two or more radars;
determining a minimum separation distance between the two or more radars from a maximum detection distance between the two or more radars;
determining whether interference is present between the two or more radars; and
determining a frequency and a waveform to be used by each of the two or more radars without interference.

8. The frequency reuse method of claim 7, wherein the determining a frequency and a waveform to be used by each of the two or more radars without interference comprises allocating a signal having an up-chirped Linear Frequency Modulation (LFM) waveform and a signal having a down-chirped LFM waveform to the respective two or more radars, the signal having the up-chirped LFM waveform and the signal having the down-chirped LFM waveform having an identical frequency band.

9. The frequency reuse method of claim 8, wherein a distance between the two or more radars exceeds twice the minimum separation distance.

10. The frequency reuse method of claim 8, further comprising:
transmitting the signal having the up-chirped LFM waveform and the signal having the down-chirped LFM waveform, having the same frequency band, from the two or more radars to an ocean surface; and
performing matched filtering between signal waveforms reflected by and received from the ocean surface.

11. The frequency reuse method of claim 7, wherein the determining a frequency and a waveform to be used by each of the two or more radars without interference comprises combining a plurality of frequency bands with the signal having the up-chirped LFM waveform and the signal having the down-chirped LFM waveform and simultaneously allocating the combined frequencies and signal waveforms to the two or more radars.

12. The frequency reuse method of claim 11, wherein a distance between the two or more radars is less than twice the minimum separation distance.

13. The frequency reuse method of claim 7, further comprising determining whether the frequency reuse method has ended or not.
